(19) United States
(12) Patent Application Publication
(10) Pub. No.: US 2016/0114681 A1
(43) Pub. Date: Apr. 28, 2016

(54) Structure Of Generator Of Motor Vehicle

(71) Applicant: Chin-Yuan Chung, Changhua County (TW)

(72) Inventor: Chin-Yuan Chung, Changhua County (TW)

(21) Appl. No.: 14/523,961

(22) Filed: Oct. 27, 2014

(51) Int. Cl. B60K 25/08; H02K 5/04

(52) U.S. Cl. CPC B60K 25/08; H02K 5/04

(57) ABSTRACT

A generator of a vehicle includes a hollow housing having two ends respectively forming a bottom that includes a first through hole rotatably coupled to at least a wheel axle of the vehicle and an opening and also having an inner circumferential wall to which magnetic elements are circumferentially arranged and mounted; a cover, which includes a second through hole formed therein to correspond to the first through hole and rotatably fit to a rotation shaft and has one side coupled to the housing and an opposite side coupled to a wheel rim, the rotation shaft having an end to which at least one coil assembly is mounted to be received in the housing and spaced from the magnetic elements and an opposite end to which a toothed disc is mounted; and driving bars rotatably mounted to one side of the cover and each in engagement with the toothed disc.

### BACKGROUND OF THE INVENTION

(a) Technical Field of the Invention

The present invention generally relates to an improved structure of a generator of a motor vehicle, and more particularly to a device that is mountable to a shell of a transportation vehicle, such as an automobile, a motorcycle, an electrical moped, a bicycle and the likes.

(b) Description of the Prior Art

Since people are overly relying on fossil fuel energy, it is now global weakening of energy crisis. Due to the tremendous pollution and damage to the environment caused by combustion of fossil fuel, it is now the focusing issue of energy saving and environmental protection. Under such a trend, besides the development of new sources of energy, reuse of energy is considered another measure of environmental protection and saving of energy.

A variety of electrical vehicles that are capable of self-power generation are available currently, which generally makes use of the kinetic power generated by the operation of a motor to generate electrical power and charges the electrical power back to a battery so that the battery may sustain the supply of electricity to the motor to maintain the operation of the motor for driving the vehicle forward thereby achieving an effect of cyclic use of energy. However, in such a mode of power generation, the rotational speed of the motor is often coupled to an accelerator system of the vehicle and is controlled by the accelerator system of the vehicle. The kinetic power can be converted into electrical power only when the rotational speed of the motor reaches a predetermined rating speed. Thus, when the operation of the motor is shut down during braking and downhill travel of the vehicle, no electrical power is generated. Thus, there is room for further improvement.

The present invention aims to provide an improved generator structure of a motor vehicle that allows for easy installation and does not require the rotational speed of the motor to reach a predetermined speed in order to overcome the drawbacks of the conventional generator structures.

### SUMMARY OF THE INVENTION

The primary object of the present invention is to provide an improved structure of a generator of a motor vehicle that allows for easy installation.

A secondary object of the present invention is to provide an improved structure of a generator of a motor vehicle, which is compact and does not occupy a substantial amount of space in a workshop.

To achieve above objects, the present invention provides an improved structure of a generator of a motor vehicle, which comprises: a hollow housing having two ends respectively forming a bottom and an opening, the bottom being provided, at a center thereof, with a first through hole, the housing having an inner circumferential wall to which a plurality of magnetic elements is circumferentially arranged and mounted, the first through hole being rotatably coupled to at least a wheel axle of the vehicle; a cover, which comprises a second through hole formed therein to correspond to the first through hole, the cover having one side coupled to the housing to close the opening, the cover having an opposite side coupled to a wheel rim, the second through hole being rotatably fit to a rotation shaft, the rotation shaft having an end to which at least one coil assembly is mounted to be received in the housing and spaced from each of the magnetic elements by a predetermined distance, the rotation shaft having an opposite end to which a toothed disc is mounted; and a plurality of driving bars, which is rotatably mounted to one side of the cover, each of the driving bars having an end in mating engagement with the toothed disc, whereby the wheel rim drives the cover, the housing, and each of the driving bars to rotate to have each of the driving bars drive the toothed disc to rotate in an opposite direction so that the coil and the magnetic elements are rotated in opposite directions to achieve an effect of generation of electrical power.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing an improved structure of a generator of a motor vehicle according to the present invention.

FIG. 2 is another perspective view of the present invention taken from an different angle.

FIG. 3 is an exploded view of the improved structure of the generator of the motor vehicle according to the present invention.

FIG. 4 is another exploded view of the present invention taken from a different angle.

FIG. 5 is a schematic view illustrating the improved structure of the generator of the motor vehicle according to the present invention combined with a vehicle wheel.

FIG. 6 is a schematic view illustrating a use of an improved structure of a generator of a motor vehicle according to another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

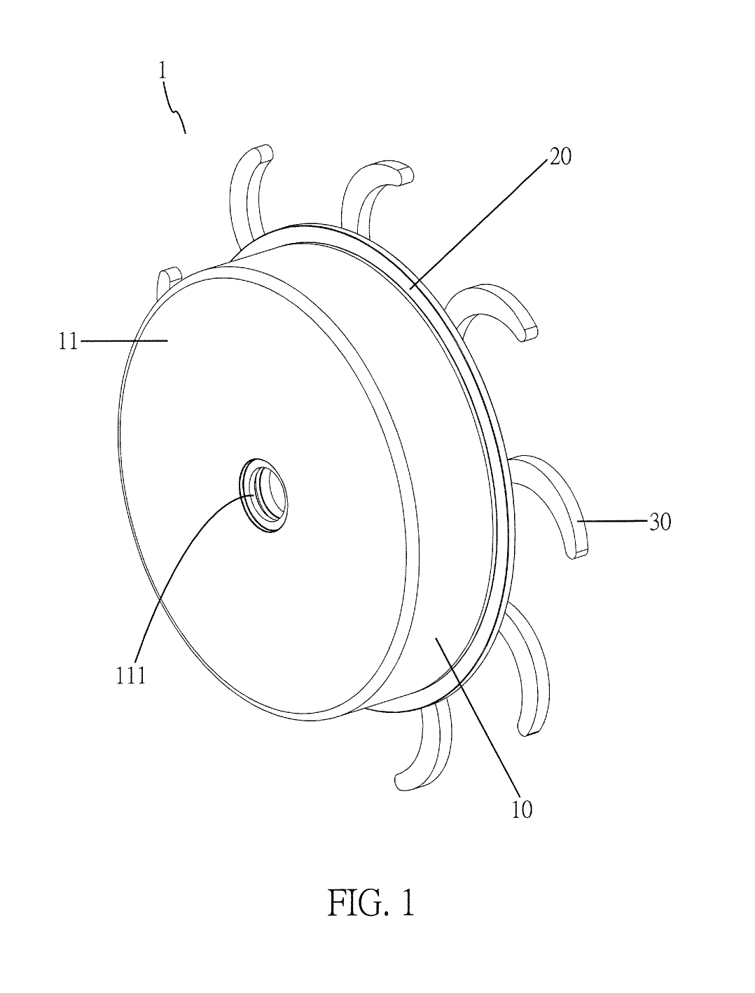

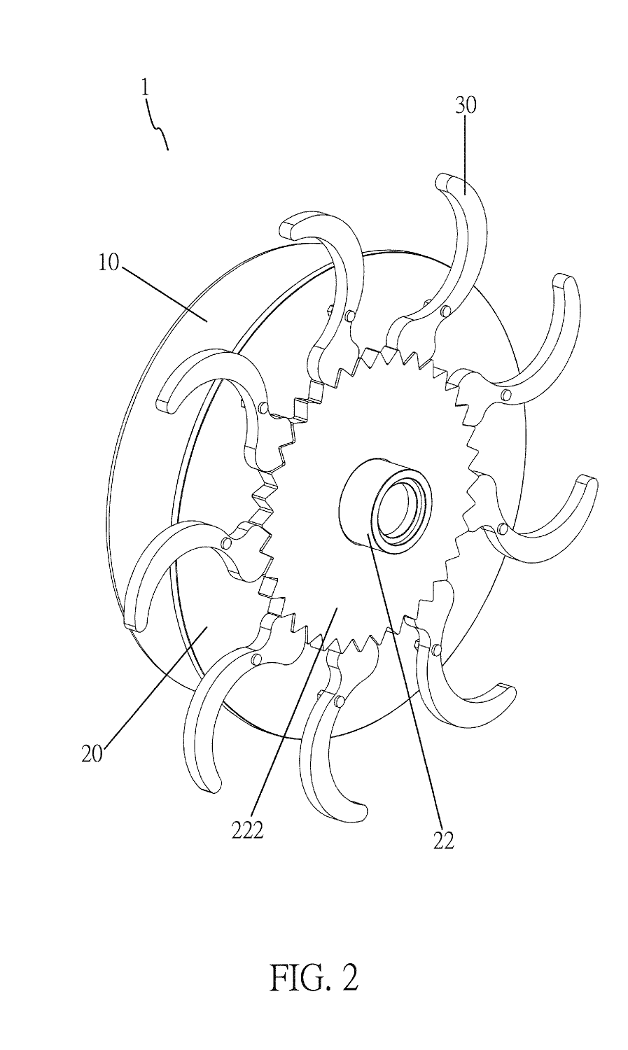

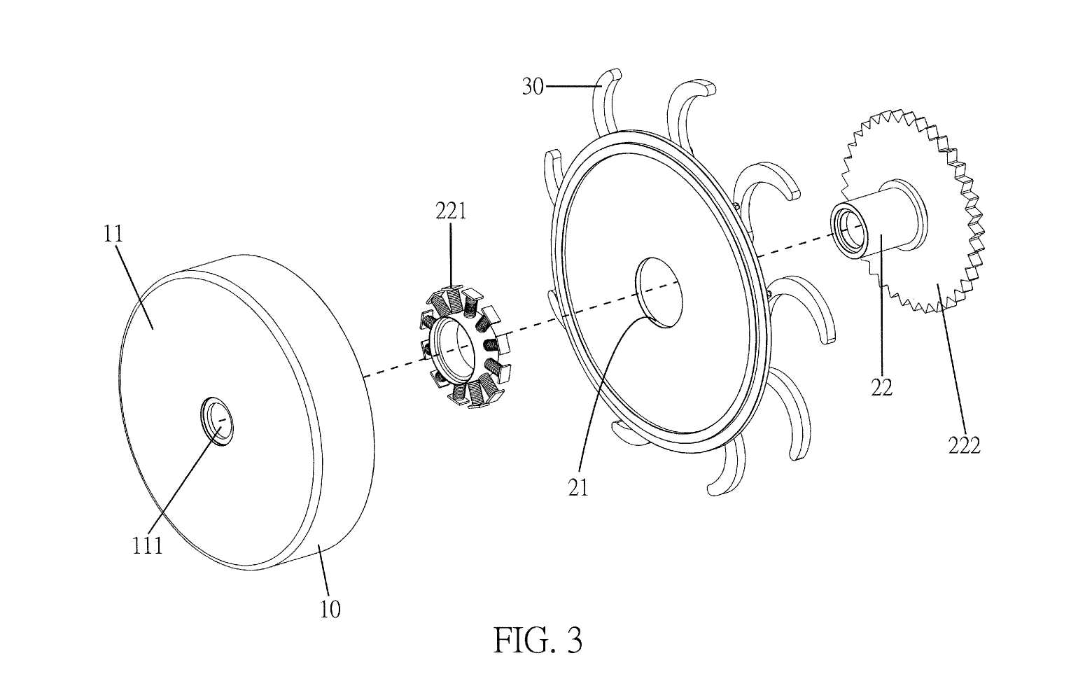

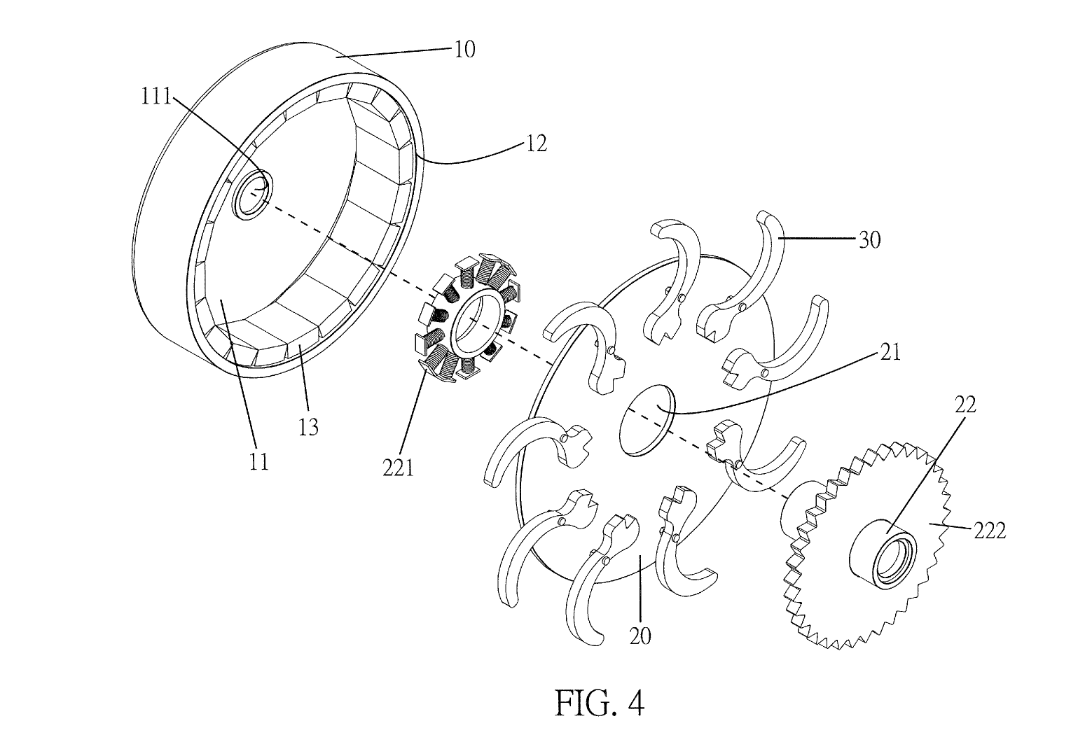

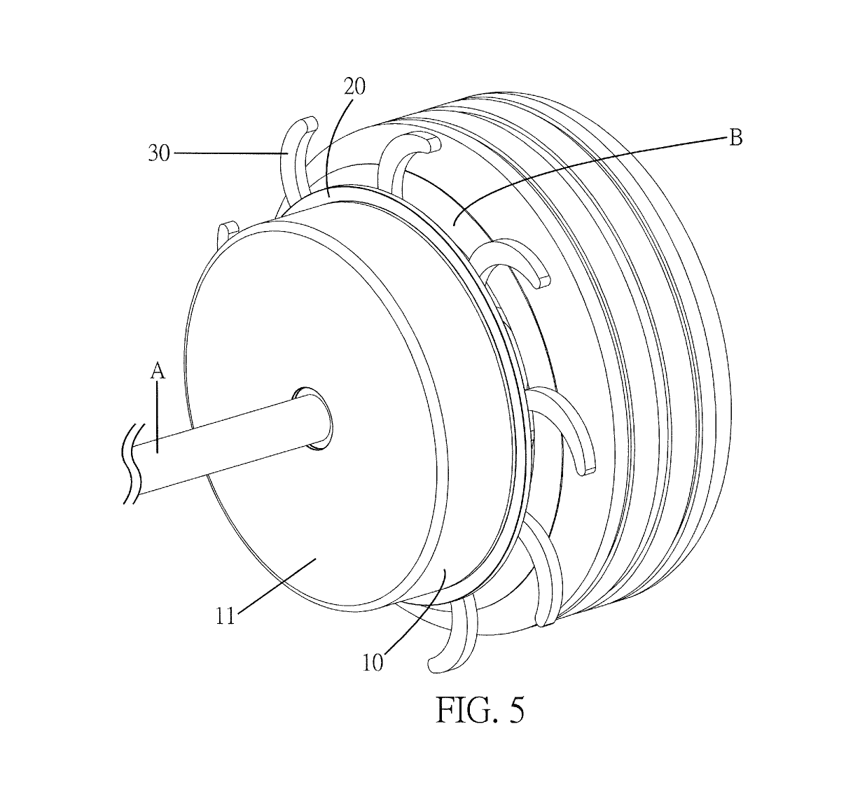

Referring to FIGS. 1-5, the present invention provides an improved structure of a vehicle generator, generally designated at 1, which comprises: a hollow housing 10, which has two ends respectively forming a bottom 11 and an opening 12. The bottom 11 is provided, at a center thereof, with a first through hole 111. The housing 10 has an inner circumferential wall on which a plurality of magnetic elements 13 are circumferentially arranged and mounted. The first through hole is arranged for rotatably mounted to at least one wheel axle A of a vehicle.

A cover 20 comprises a second through hole 21 formed therein to correspond to the first through hole 111. The cover 20 has one side coupled to the housing 10 to close the opening 12. The cover 20 has an opposite side coupled to a wheel rim B of the vehicle. The second through hole 22 is rotatably fit and coupled to a rotation shaft 22. The rotation shaft 22 has an end to which at least one coil assembly 221 is mounted to be received in the housing 10 but spaced from each of the magnetic elements 13 by a predetermined distance. The rotation shaft 22 has an opposite end to which a toothed disc 222 is mounted.

A plurality of driving bars 30 is rotatably mounted to one side of the cover 20. Each of the driving bars 30 has an end that is set in mating engagement with the toothed disc 222 so that the wheel rim B may drive the cover 20, the housing 10, and each of the driving bars 30 to rotate in such a way that each of the driving bars 30 may drive the toothed disc 222 to rotate whereby the coil 221 and the magnetic elements are rotated in the same direction to achieve an effect of generation of electrical power.

When the vehicle is moving forward, the wheel rim B drives the cover 20 to rotate, making the driving bars 30 sequentially contact the ground surface so as to drive the toothed disc 222 to rotate. Since the cover 20 is coupled to the housing 10, the cover 20 and the housing 10 are rotated in unison with the wheel rim B, while the toothed disc 222 and the coil assembly 221 are rotated in synchronization with each other, whereby the magnetic elements 13 that are located in side the housing 10 are made rotatable about and with respect to the coil assembly 221 in such a way that the housing 10 and the rotation shaft 22 are rotated in the same direction.

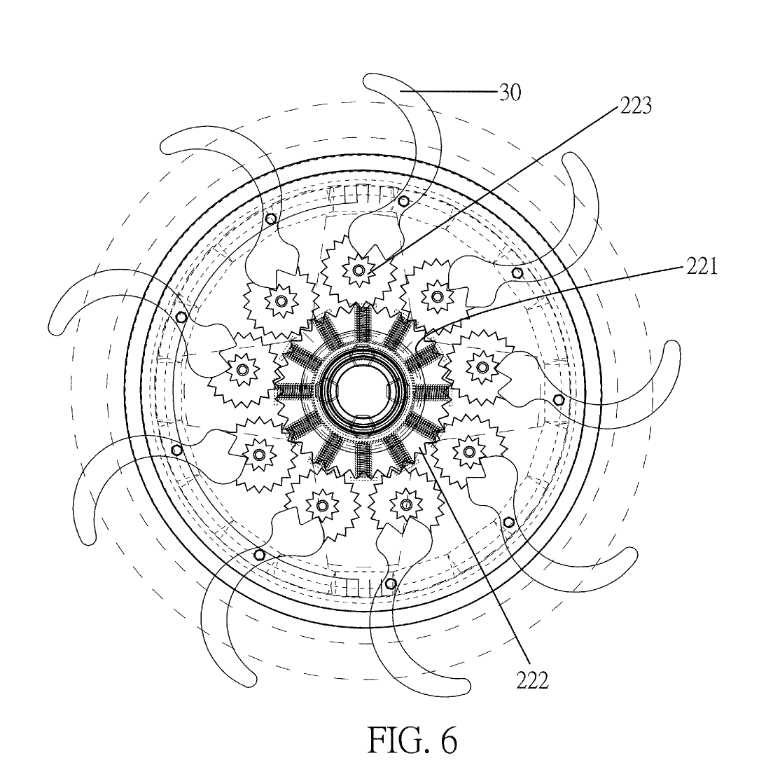

Referring to FIG. 6, an improved structure of a vehicle generator according to a second embodiment, also designated with reference numeral 1, is shown, wherein the cover 20 further comprises a plurality of secondary toothed discs 223 rotatably mounted thereto to mate the toothed disc 222. Each of the driving bars 30 is set in mating engagement with each of the secondary toothed discs 223. The operation is generally identical to what described with reference to the pervious embodiment, with the only difference being that the secondary toothed discs 223 are included and arranged for the purposes of saving effort.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An improved structure of a generator of a vehicle, comprising:
a housing, which has two ends respectively forming a bottom and an opening, the bottom being provided, at a center thereof, with a first through hole, the housing having an inner circumferential wall to which a plurality of magnetic elements is circumferentially arranged and mounted, the first through hole being adapted to be rotatably coupled to a wheel axle of a vehicle;
a cover, which comprises a second through hole formed therein to correspond to the first through hole, the cover having one side coupled to the housing to close the opening, the cover having an opposite side adapted to be coupled to a wheel rim, the second through hole being rotatably fit and coupled to a rotation shaft, the rotation shaft having an end to which at least one coil assembly is mounted to be received in the housing but spaced from each of the magnetic elements by a predetermined distance, the rotation shaft having an opposite end to which a toothed disc is mounted; and
a plurality of driving bars, which is rotatably mounted to one side of the cover, each of the driving bars having an end that is in mating engagement with the toothed disc so that the wheel rim drives the cover, the housing, and each of the driving bars to rotate in such a way that each of the driving bars drives the toothed disc to rotate in an opposite direction whereby the coil and the magnetic elements are rotated in opposite directions to achieve an effect of generation of electrical power.

2. The improved structure of a generator of a vehicle according to claim 1, wherein the cover comprises a plurality of secondary toothed discs rotatably mounted thereto to mate the toothed disc, each of the driving bars being in mating engagement with each of the secondary toothed discs.
